(19) United States
(12) Patent Application Publication
(10) Pub. No.: US 2026/0348446 A1
(43) Pub. Date: Nov. 5, 2026

(54) AIR SPRING VALVE, AIR SPRING HAVING SUCH AN AIR SPRING VALVE, AND MOTOR VEHICLE

(71) Applicant: Solero Technologies Villingen GmbH, Villingen-Schwenningen (DE)

(72) Inventors: Michael TISCHTSCHENKO, Trossingen (DE); Holger BRANDENBURG, Villingen-Schwenningen (DE)

(21) Appl. No.: 19/487,281

(22) PCT Filed: Feb. 6, 2024
(86) PCT No.: PCT/EP2024/052875

§ 371 Date: Nov. 24, 2025

(30) Foreign Application Priority Data
May 25, 2023 (DE) 10 2023 113 846.4

(51) Int. Cl. F16F 9/36; B60G 11/27; B60G 17/052; F16F 9/02; F16F 9/44; F16K 31/06

(52) U.S. Cl. CPC F16F 9/369; F16F 9/029; F16F 9/446; F16K 31/0624; B60G 11/27; B60G 17/0525; B60G 2202/152; B60G 2204/62; B60G 2206/42; B60G 2500/30; B60G 2800/914; F16F 2222/126; F16F 2226/04; F16F 2228/066; F16F 2230/30

(57) ABSTRACT

The present invention relates to an electromagnetic air spring valve. The air spring valve includes an electrically actuatable actuation device with a coil and an armature which can be moved along a longitudinal axis. The armature is coupled to a valve element which can interact sealingly with a valve seat in an air channel to close the air channel. Between the valve element and the valve seat an elastic sealing element is held to close the air channel in a form-and/or force-fitting manner. The present invention further relates to an air spring and to a motor vehicle having an air spring of this type. 33466898

### CROSS-REFERENCE TO RELATED APPLICATIONS

This application is the National Stage of International Application No. PCT/EP 2024/052875 filed on Feb. 6, 2024, which claims priority to and all advantages of German Patent Application No. 10 2023 113 846.4 filed on May 25, 2023, the disclosures of which are hereby incorporated by reference in their entirety.

### FIELD OF THE INVENTION

The present invention relates to an air spring valve, in particular for the controlled supply of compressed air into an air channel between two air chambers. Furthermore, the invention also relates to an air spring and a motor vehicle with such an air spring.

### BACKGROUND

Air-spring valves are known from the prior art in various designs. Air spring valves are used, among other things, in air springs for motor vehicles with pneumatic suspension. The spring rate of the air spring is determined by the air chamber volume. The air chamber volume is divided into a first pressure chamber, also known as the spring chamber, and a second pressure chamber, also known as the additional chamber. The two chambers can be separated by the air spring valve. This reduces the total volume of the air spring chamber. The spring rate increases with a smaller air volume.

Air spring valves are a proven technology from the past, but even the smallest leaks are noticeable during operation of such an air spring, which can have a negative effect on the spring rate. For this reason, air spring valves often have a complex design, particularly in terms of production.

### SUMMARY

The present invention is therefore dedicated to the task of proposing an air spring valve which is suitably improved compared to the state of the art. On the one hand, the air spring valve should be inexpensive to manufacture and, on the other hand, seal the air channel as well as possible when the air spring valve is closed.

This task is solved by an air spring valve, an air spring, and a motor vehicle.

The electromagnetic air spring valve according to the invention has an electrically operable actuating device with a coil and an armature movable along a longitudinal axis. The armature of the electromagnetic air spring valve is coupled to a valve element which can interact sealingly with a valve seat in an air channel to close the air channel. When the air spring valve is closed, the valve seat and the valve element work together to close the air channel. When the air spring valve is open, the air channel is unblocked. According to the invention, an elastic sealing element is also arranged, which is held between the valve element and the valve seat in a positive-locking and/or force-locking manner to close the air channel in the longitudinal axis.

The present invention is based on the idea of arranging an elastic sealing element which, in the closed state of the air spring valve, is arranged between the valve seat and the valve element and rests both sealingly against the valve seat and sealingly against the valve element. The sealing element is a single component that can be surrounded on all sides. Accordingly, when the air spring valve is closed, the sealing element seals a first gap between the valve element and the sealing element and a second gap between the sealing element and the valve seat. The sealing element can compensate for manufacturing inaccuracies and wear.

It should be noted at this point that the elastic sealing element can be arranged loosely in particular. It is preferably held in position solely by a positive and/or frictional connection. Consequently, the elastic sealing element is not fixed in place by a material-locking connection, in particular by vulcanization, which simplifies the manufacture of an air filter valve according to the proposal and enables cost savings in manufacture. In the simplest case, the elastic sealing element can be a sealing ring, which is preferably in the shape of a torus and has a square cross-section.

A further development of the present invention provides that the valve seat and the valve element each have a sealing collar, and that the elastic sealing element for closing the air channel is arranged between the two sealing collars. The respective sealing collar is preferably designed as an annular projection with a V-shaped cross-section. When the air spring valve is closed, the two sealing collars are in sealing contact on opposite sides of the sealing element.

According to a preferred further development of the invention, the two sealing collars are facing towards each other. The two sealing collars therefore protrude freely in the longitudinal axis from the valve seat and the valve element. It has also proven to be advantageous if the two sealing collars are aligned with each other. In particular, the two sealing collars are arranged with the same corresponding diameters in relation to the longitudinal axis, which keeps the sealing element in pressure-equalization. However, it should be noted at this point that in an alternative embodiment, the sealing collars can be designed with different diameters in order to achieve an offset in the pressure equalization of the sealing element.

Furthermore, it has proven to be advantageous if the sealing element is held on the valve seat and/or on the valve element by a cap. In particular, it is preferred if the sealing element is held positively and/or non-positively on the valve element and/or on the valve seat by a raised cap. The cap makes it possible to attach the sealing element in a cost-effective and simple manner, which saves costs in the manufacture of the proposed air filter valve.

Furthermore, an advantageous embodiment of the present invention provides that the elastic sealing element has two sealing surfaces which are formed on opposite sides along the longitudinal axis. In particular, it is preferred if the elastic sealing element is an approximately cuboid sealing ring.

According to an advantageous further development of the present invention, the valve element is pot-shaped or concave in the direction of the valve seat. In an advantageous embodiment, the valve element can also have a valve element tappet coupled to the armature, which has a valve element base at its end facing away from the armature, from which a circumferential valve element collar projects in the direction of the valve seat to form the pot-shaped or concave configuration. The pot-shaped or concave design creates a receiving area on the side facing away from the armature.

Furthermore, it has proven to be advantageous if the valve element has a circumferential collar on which the sealing collar is arranged. The circumferential collar preferably protrudes from the valve element collar in the manner of a flange, whereas the sealing element is preferably attached to the valve element or, more precisely, to the valve element collar of the valve element.

A further development of the present invention provides that the valve element and/or the armature have a through-hole along the entire length along the longitudinal axis. The through-hole enables communication between a valve chamber and a pressure equalization chamber, which is preferably formed on the side of the armature facing away from the valve element. The through-hole is used for approximately fully pressure-equalized operation of the air spring valve, which means that even small forces are sufficient to open or close the air spring valve. Accordingly, the electrically operated actuating device can be designed to be smaller.

Furthermore, it has proven to be advantageous if the air spring valve has a spring device by which the valve element is held in an open position when the air spring valve is de-energized. The spring device advantageously presses the valve element against the armature, whereas the armature is moved into its initial position by means of the valve element when the air spring valve is de-energized.

According to a further advantageous embodiment of the present invention, the valve element is formed from a plastic. In particular, it is preferable if the valve element is made of an injection-molded part. As previously mentioned, the elastic sealing element can compensate for manufacturing inaccuracies.

The armature and the valve element can be loosely connected to each other. In other words, the valve element can abut loosely against the armature, resulting in a particularly simple design of the proposed air spring valve.

A second aspect of the present invention relates to an air spring, in particular of a motor vehicle, with a first air chamber and a second air chamber connected by the air channel and with a previously described air spring valve. The air spring can comprise a bellows, in particular a rolling bellows.

Furthermore, a third, final aspect of the present invention relates to a motor vehicle with an air spring as described above.

### BRIEF DESCRIPTION OF THE DRAWINGS

With reference to the accompanying figure, a design example of the present invention is described in detail below. In the figures:

FIG. 1 is a sectional view of an air spring valve with a valve element that can be operated by an actuating device, a valve seat and a sealing element arranged between the valve element and the valve seat, and

FIG. 2 is an enlarged, detailed view of the valve element with the sealing element. Identical or functionally identical parts or features are identified with the same reference signs in the following detailed description of the figures. Additionally, not all identical or functionally identical parts or features are given a reference number in the figures.

### DETAILED DESCRIPTION

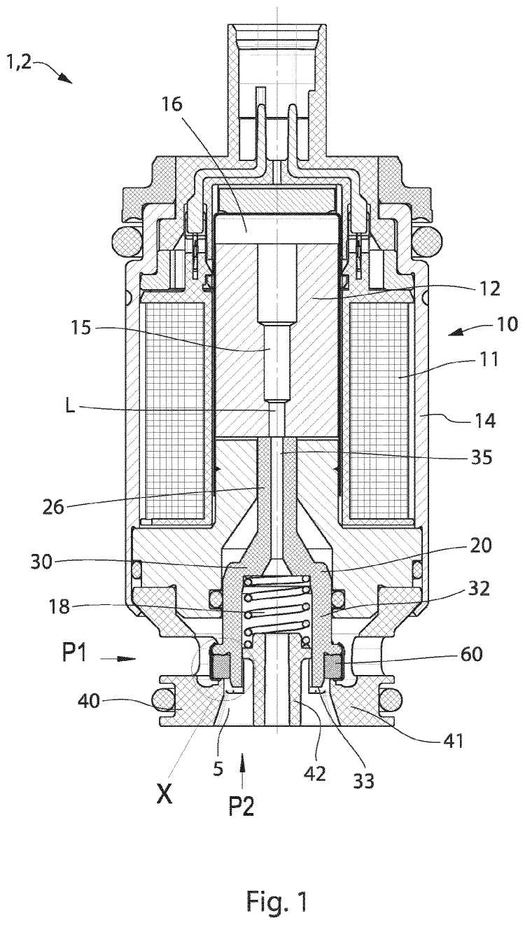

FIG. 1 is a first exemplary embodiment of an air spring valve 1. An air spring valve 1 can be used to control or regulate a pressure in an air spring 2, which is only indicated schematically, in particular of a motor vehicle (not shown), for example to adjust a vehicle height.

The air spring 2 comprises a first air chamber P1 and a second air chamber P2. The first air chamber P1 and the second air chamber P2 are fluidically connected to each other via an air channel 5, whereas the air channel 5 is guided through the air spring valve 1. The air spring valve 1 described in detail below can close and open the air channel 5, whereas compressed air can flow through the air channel 5 when the air spring valve 1 is open and no fluid communication can take place between the first air chamber P1 and the second air chamber P2 when the air spring valve 1 is closed. The air channel 5 is closed in this state.

The air spring valve 1 comprises an electrically operable actuating device 10 with a coil 11, an armature 12 movable along a longitudinal axis L and a spring device 18.

When the electrically operable actuating device 10 is actuated, the coil 11 is energized and the armature 12 is moved in a known manner along the longitudinal axis L against a spring force of the spring device 18 into the position shown in FIG. 1. In the unactuated state, the coil 11 is de-energized and the armature 12 is moved back into an initial position (not shown) by the spring force.

In addition, the air spring valve 1 comprises a valve element 20, which is coupled to the movable armature 12, and a valve seat 40. The valve element 20 and the valve seat 40 can interact in a valve chamber 44 and the valve element 20 can close the air channel 5 with the valve seat 40.

In the exemplary embodiment shown, when the electrically operated actuating device 10 is actuated, the valve element is closed by the armature 12 in such a way that the air channel 5 is closed. When not actuated, i.e., when the coil 11 is de-energized, the air spring valve 1 is open. Such an air spring valve 1 is referred to as “normally open” or “NO”.

It should be noted at this point that the air spring valve 1 can also be designed so that the air spring valve 1 is closed by the spring force of the spring device 18 when the coil 11 is de-energized. Such an air spring valve 1 is referred to as “normally closed” or “NC”.

The valve element 20 is movably mounted in an actuator housing 14 along the longitudinal axis L and, in a preferred embodiment, can be made of a plastic, in particular in an injection molding process.

The valve element 20 comprises a valve element plunger 26, a valve element base and a valve element collar 32.

The valve element 20 is not connected to the armature 12, but the valve element tappet 26 of the valve element 20 rests loosely against the armature 12 on the side of the armature 12 facing the valve element. At its end facing away from the armature 12, the valve element tappet 26 has the valve element base 30, from which a circumferential valve element collar 32 extending along the longitudinal axis in the direction of the valve seat 40 projects or protrudes. The valve element 20 is therefore pot-shaped or concave and has a receiving area in which the spring device 18 can be accommodated.

According to the embodiment example shown in the accompanying figures, a sealing element 60 is arranged on the valve element 20, which is positively and/or non-positively attached to the valve element 20.

The valve element 20 and the sealing element 60 protrude into the valve chamber 44, with the air channel 5 passing through the valve chamber 44.

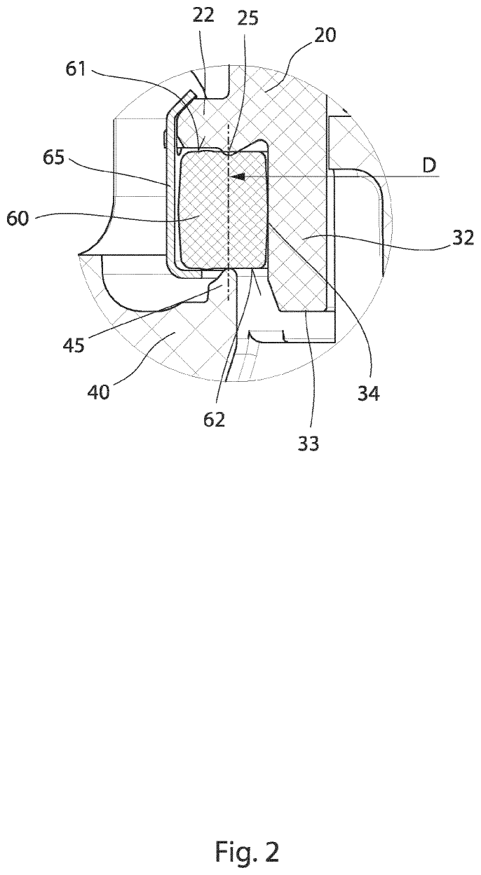

As can be seen in detail in FIG. 2, the valve element 20 comprises a circumferential collar 22, which protrudes from the valve element collar 32 in the manner of a flange. The circumferential collar 22 is arranged in the longitudinal axis L between a free end 33 of the valve element collar 32 and the valve element base 30, wherein preferably the circumferential collar 22 is arranged adjacent to the free end 33 of the valve element collar 32 in such a way that the sealing element 60 can be placed or plugged onto the valve element 20 on a receiving section 34 between the collar 22 and the free end 33.

In addition, the valve element 20 has a sealing collar 25 which protrudes from the valve element 20 along the longitudinal axis L. The sealing collar 25 is designed as a projection, preferably coaxially about the longitudinal axis, with a V-shaped cross-section. According to the illustrated embodiment example, the sealing collar 25 can be arranged on the side of the collar 22 facing the valve seat 40.

The sealing element 65 is designed as a sealing ring, preferably made of rubber. The sealing element 60 can preferably be rectangular in cross-section and also preferably has two sealing surfaces 61, 62 lying opposite each other along the longitudinal axis L.

The sealing element 60 is an individual component that is arranged on the valve element 20 in such a way that the flow can theoretically flow around it. The sealing element 60 lies on the outside of the receiving section 34 on the valve element collar 32 and rests on the sealing collar 25 along the longitudinal axis L.

As can be seen from the enlarged representation according to FIG. 2, the sealing element 60 is held on the valve element 20 by a preferably sleeve-shaped cap 65, wherein the cap 65 preferably positively secures the sealing element 60 to the valve element 20. The cap 65 can be raised, allowing the sealing element 60 to be attached to the valve element 20 in a particularly simple and cost-effective manner.

The cap 65 surrounds the collar 22 and the sealing element 65 in some areas.

The valve chamber 44 can be partially formed by a valve housing 41, whereas the valve seat 40 and/or a bearing bolt 42 can be formed on the valve housing 41. The valve housing 41 can be connected to the actuator housing 14 by suitable means and enclose the valve chamber 44 with the actuator housing 14.

The bearing bolt 42 serves to support the spring device 18 and the spring device 18 can be arranged between the bearing bolt 42 and the receptacle of the valve element 20 or its valve element base 30.

The valve chamber 44 is pneumatically connected to a pressure equalization chamber 16, which is arranged in the actuator housing 14 on the side of the armature 12 facing away from the valve chamber. For the pneumatic connection, both the valve element 20 and the armature 12 have a through-hole 15, 35. The through-hole 15 penetrates the armature 12 and the through-hole 35 completely penetrates the valve element 20 along the longitudinal axis L.

As can be seen in particular from the enlarged illustration in FIG. 4, the valve seat comprises a sealing collar 45. The sealing collar 45 is designed as a projection, preferably coaxially about the longitudinal axis L, with a V-shaped cross-section. The sealing collar 45 corresponds to the sealing collar 25 of the valve element 20, whereas the sealing collar 45 and the sealing collar 25 are preferably arranged on the same diameter in relation to the longitudinal axis L.

The sealing collar 45 is preferably arranged in the valve chamber 44 on the side opposite the armature 12 and projects further preferably in the direction of the sealing collar 25 of the valve element 20.

When the air spring valve 1 is closed, the sealing element 60 is clamped between the valve seat 40 and the valve element 20 and is therefore in sealing contact with both the valve seat 40 and the valve element 20.

More precisely, when the air spring valve is closed, the sealing element 60 is clamped between the two sealing collars 25, 45.

The two sealing collars 25, 45 preferably have the same diameter in relation to the longitudinal axis L. In FIG. 2, this diameter is indicated by the reference sign D. Due to the same diameter, pressure equalization between the two sealing collars 25, 45 can be achieved. However, it may well be advisable to apply an offset to the pressure equalization. This can be achieved by different diameters in which the sealing collars 25, 45 are arranged.

### LIST OF REFERENCE SYMBOLS

1 air spring valve
2 air spring
5 air channel
10 actuating device
11 coil
12 armature
14 actuator housing
15 through-hole
16 pressure equalization chamber
18 spring device
19 sealing device
20 valve element
22 collar
25 sealing collar
26 valve element tappet
30 valve element base
32 valve element collar
35 through-hole
40 valve seat
41 valve housing
42 bearing bolt
44 valve chamber
45 sealing collar
60 sealing element
61 sealing surfaces
62 sealing surfaces
62 cap
L longitudinal axis
P1 air chamber
P2 air chamber

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An electromagnetic air spring valve comprising:
an electrically operable actuating device with a coil and an armature movable along a longitudinal axis
wherein the armature is coupled to a valve element which can interact in a sealing manner with a valve seat in an air channel to close the air channel
wherein an elastic sealing element for closing the air channel is arranged between the valve element and the valve seat in a positive-locking or force-locking manner.

2.The air spring valve according to claim 1, wherein the valve seat and the valve element each have a sealing collar and wherein the elastic sealing element for closing the air channel is arranged between the two sealing collars.

3. The air spring valve according to claim 1, wherein the elastic sealing element is held by a preferably raised cap to at least one of the two sealing collars.

4. The air spring valve according to claim 1, wherein the elastic sealing element has who sealing surfaces which are arranged opposite one another along a longitudinal axis.

5. The air spring valve according to claim 1, wherein the elastic sealing element is a a cuboid sealing ring.

6. The air spring valve according to claim 1, wherein the valve element is pot-shaped or concave in the direction of the valve seat.

7. The air spring valve according to claim 1, wherein the valve element has a circumferential collar with the sealing collar, and wherein the sealing element is placed onto the valve element.

8. The air spring valve according to claim 1, wherein the valve element has a valve element tappet which is coupled to the armature and has, at its end facing away from the armature, a valve element base from which a circumferential valve element collar projects in the direction of the valve seat.

9. The air spring valve according to claim 1, wherein the valve element has a through-hole along its entire length along the longitudinal axis or wherein the armature has a through-hole along its entire length.

10. The air spring valve according to claim 1, wherein a spring device is provided so that the valve element is held in a position in which the valve seat is open when the air spring valve is de-energized.

11. The air spring valve according to claim 1, wherein the valve element is made of plastic and, in an injection-molded part.

12. The air spring valve according to claim 1 wherein the armature and the valve element are loosely connected with each other.

13. An air spring comprising:
a first air chamber and a second air chamber connected by an air channel; and
an the air spring valve according to claim 1.

14. A motor vehicle with the air spring according to claim 13.
